(19) United States
(12) Patent Application Publication
(10) Pub. No.: US 2013/0067379 A1
(43) Pub. Date: Mar. 14, 2013

(54) GRAPHICAL COMPARISON OF GEOGRAPHIC INFORMATION SYSTEM DATA

(71) Applicants: Sumathi Chutkay, Hyderabad (IN); Raja Rao Budaraju, Hyderabad (IN); Bhimesh Kumar Katta, Hyderabad (IN); Vamshi Krishna Sadhu, Hyderabad (IN)

(72) Inventors: Sumathi Chutkay, Hyderabad (IN); Raja Rao Budaraju, Hyderabad (IN); Bhimesh Kumar Katta, Hyderabad (IN); Vamshi Krishna Sadhu, Hyderabad (IN)

(73) Assignee: GENERAL ELECTRIC COMPANY, Schenectady, NY (US)

(21) Appl. No.: 13/231,421

(22) Filed: Sep. 13, 2011

(51) Int. Cl. G06F 3/048

(52) U.S. Cl. 715/771; 715/781

(57) ABSTRACT

Exemplary embodiments include a method for generating a graphical comparison of geographic information system data in a computer system. The computer system can include a graphical user interface including a display and a selection device. The method can include displaying a plurality of controls on the display, each of the plurality of controls for generating a response in geographic information system data on the display, receiving a geographic information system data selection signal indicative of the selection device pointing at a geographic information system data selection control on the graphical user interface, and in response to the geographic information system data selection signal, retrieving geographic information system data from a geographic information system database for display on the graphical user interface, wherein the geographic information system data includes data from at least one historical point in time.

### BACKGROUND OF THE INVENTION

The subject matter disclosed herein relates to geographic information systems, and more particularly to systems and methods for comparing historical data between dates.

A geographic information system (GIS), geographical information system, or geospatial information system is any system that captures, stores, analyzes, manages, and presents data that are linked to location(s). GIS may be used in several types of search engines such as those associated with public utility management. GIS can digitally create and “manipulate” spatial areas that may be jurisdictional, purpose or application oriented for which a specific GIS is developed. Therefore, GIS describes any information system that integrates, stores, edits, analyzes, shares, and displays geographic information for informing decision making. GIS applications are tools that allow users to create interactive queries (user-created searches), analyze spatial information, edit data, maps, and present the results of all these operations.

In GIS, spatial and a-spatial data evolve in a chronological way over a long period of time. Due to these long transactions, it is difficult to assess the way data has changed from its previous states. Also, GIS exchanges asset information with enterprise systems. For example, the workflow management system (WMS) handles business processes in such a manner that automates the manual steps and involves transition of an activity from one state to another. GIS imports asset data from WMS, which can change from one state to another state during WMS workflow. Even during synchronization of GIS data between two systems, such as GIS and field GIS, there is a need to know how data got changed before and after. As such, there is a need to have a visual comparison between GIS and other enterprise system and between data within GIS at various points in time and between various scenarios.

### BRIEF DESCRIPTION OF THE INVENTION

According to one aspect of the invention, a method for generating a graphical comparison of geographic information system data in a computer system is described. The computer system can include a graphical user interface including a display and a selection device. The method can include displaying a plurality of controls on the display, each of the plurality of controls for generating a response in geographic information system data on the display, receiving a geographic information system data selection signal indicative of the selection device pointing at a geographic information system data selection control on the graphical user interface, and in response to the geographic information system data selection signal, retrieving geographic information system data from a geographic information system database for display on the graphical user interface, wherein the geographic information system data includes data from at least one historical point in time.

According to another aspect of the invention, a computer program product for graphically illustrating a comparison of geographic information system data is described. The computer program product can include a non-transitory computer readable medium storing instructions for causing a computer to implement a method computer system having a graphical user interface, including a display and a selection device. The method can include displaying a plurality of controls on the display, each of the plurality of controls for generating a response in geographic information system data on the display;, receiving a geographic information system data selection signal indicative of the selection device pointing at a geographic information system data selection control on the graphical user interface and in response to the geographic information system data selection signal, retrieving geographic information system data from a geographic information system database for display on the graphical user interface, wherein the geographic information system data includes data from at least one historical point in time.

According to yet another aspect of the invention, a system for generating a graphical comparison of geographic information system data is described. The system can include a display, a historical geographic information system database including geographic information system data that can be displayed on the display and a mark-up database including user annotation data that can be displayed on the display, wherein the display includes a first date view of the geographic information system data and a second view of the geographic information system data comparing differences between the first date view and the second date view, the user annotation data providing information related to the differences between the first date view and the second date view.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 diagrammatically illustrates an exemplary system for generating a graphical comparison of GIS data;

FIG. 2 illustrates an example of a screen shot of a graphical user interface for graphical comparison of GIS data in accordance with exemplary embodiments;

FIG. 3 illustrates an example of a screen shot of a settings graphical user interface in accordance with exemplary embodiments;

FIG. 4 illustrates an example of a screen shot of a graphical user interface for graphical comparison of GIS data with included user annotations in accordance with exemplary embodiments;

FIG. 5 illustrates an example of a screen shot of a graphical user interface for graphical comparison of GIS data in which two views have been overlapped in accordance with exemplary embodiments;

FIG. 6 illustrates a screen shot of a graphical user interface in which an animation has complete and all objects are shown;

FIG. 7 illustrates a flow chart of a method for generating graphical comparisons of GIS data in accordance with exemplary embodiments; and

FIG. 8 illustrates an exemplary embodiment of a system for generating a graphical comparison of GIS data

The detailed description explains embodiments of the invention, together with advantages and features, by way of example with reference to the drawings.

### DETAILED DESCRIPTION OF THE INVENTION

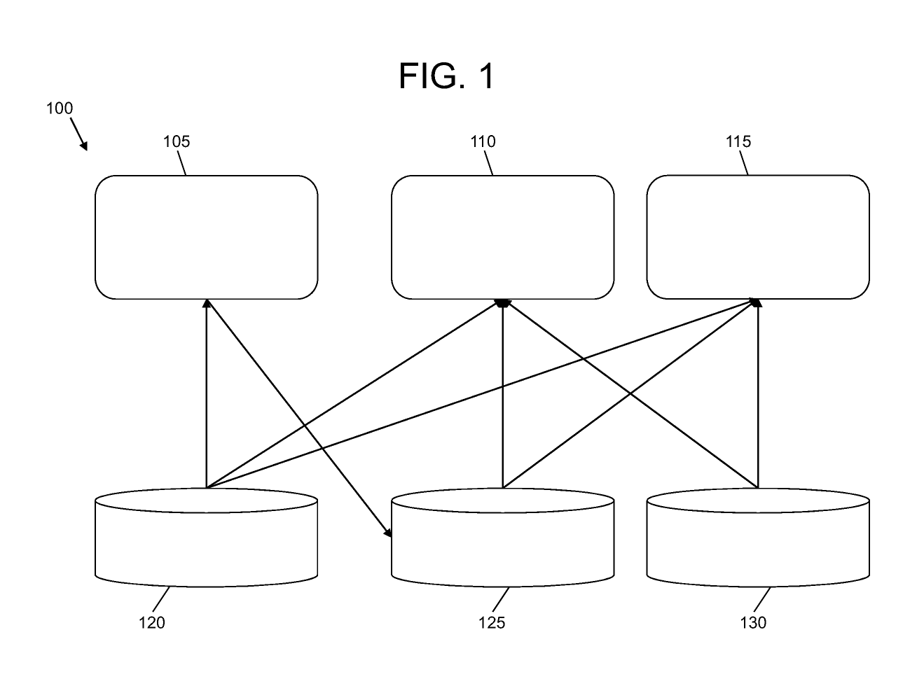

FIG. 1 diagrammatically illustrates an exemplary system 100 for generating a graphical comparison of GIS data. For illustrative purposes an example described herein is GIS data for power utility systems. It will be appreciated that the systems and methods described herein can be applied to any public utility or any system benefited by GIS comparison such as but not limited to geography, cartography, remote sensing, land surveying, natural resource management, precision agriculture, photogrammetry, urban planning, emergency management, landscape architecture, navigation, aerial video, and the like. In exemplary embodiments, the system 100 generates a comparison of GIS data evolved chronologically during engineering design, field inspection, ERP data interchange and remote replication.

The system 100 can include several views, such as on a computer screen, as described further herein. The system 100 can include a main view 105 that displays current GIS data from a main database 120 that stores current GIS data, such as from a geographical area with a current power utility layout. The system can further includes a first date view 110 and a second date view 115 that can be viewed side by side to compare the same geographical area at different dates, comparing the GIS data of the power utility layouts at the two different dates. The GIS data described herein can include any graphical objects representing different pieces of geographical information related to the view. For example, the graphical objects can include, consistent with the power utility example, but are not limited to: residences; commercial buildings; power cables; power substations; capacitors and the like. In exemplary embodiments, the system 100 can therefore further include a historical GIS database (i.e., an audit history database) 125 having historical GIS data of the geographical area, the historical GIS data including the two dates. Since GIS data goes through several changes over time, the GIS data is based on long transactions over time. Whenever changes are made, they are registered in the historical GIS database 125. The changes on GIS records are stored with a time stamp, indicating when the changes have occurred in time. As such, the historical GIS database 125 can store information related to all transactions performed in GIS along with a time stamp. This data is extracted based on a requested time stamp and used to recreate the past GIS data, such as in the main view 105 and the first date view 110 and the second date view 115.

In exemplary embodiments, the system 100 can further include a mark-up database 130 that includes user annotations that can be used to markup the various comparison views described herein, such as the first date view 110 and the second date view 115. It will be appreciated that the first date view 110 and the second date view 115 and various other exemplary views described herein can be dynamically updated with different date comparisons and user annotations.

As such, the main view 105 can replicate the current data from the main database 120. From the main view 105, historical data can be extracted from the historical GIS database 125 on a specific date and resurrect the changes in a replica view, such as the first date view 110. In this way, the system 100 can revive the GIS state for a specific date. Furthermore, the user can add user annotation for the various views, and the user annotations can be associated with the views and stored in the mark-up database 130. In exemplary embodiments, any exemplary graphical user interface (GUI) can be implemented to compare views between two dates thus tracking changes that went into the system 100.

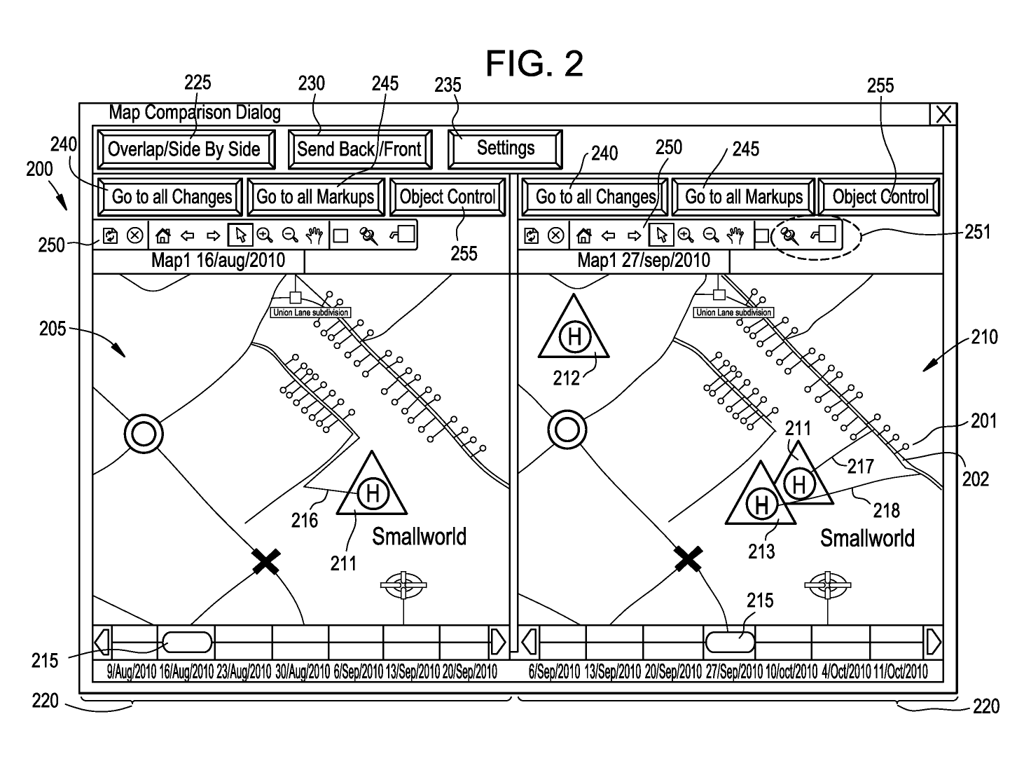

FIG. 2 illustrates an example of a screen shot of a GUI 200 for graphical comparison of GIS data in accordance with exemplary embodiments. As described further herein, the GUI 200 and other exemplary GUIs include controls that, when engaged by the user, produce an effect on the displayed GIS data. The GUI 200 illustrates a simple comparison of two dates, in the example, a first view 205 showing the date Aug. 16, 2010 and a second view 210 showing the date Sep. 27, 2010. In exemplary embodiments, the GUI 200 can include several controls to aid in the comparison of GIS data. For example, in extracting the data for particular dates from the historical GIS database 125, the GUI 200 can include a data selection control 215 having corresponding dates 220 for the views 205, 210. The GUI 200 can further include an overlap/side by side view control 225 for switching between overlapping the views 205, 210 and showing them side by side, as illustrated in FIG. 2. Overlapping the views 205, 210 is described further herein. The GUI 200 can further include a send back/front control 230 for sending selected items in the views 205, 210 front or back. A settings control 235 can select several preference settings for the dates as described further herein. A “go to all changes” control 240 can select and display all the changes between the two dates for viewing in the views 205, 210. A “go to all markups” control 245 can select and display all the user mark-ups for viewing on the views 205, 210 as further described herein. A control menu bar 250 can provide basic selection, moving and zooming tools. The control menu bar 250 can further include user annotation controls 251 as further described herein.

An object control 255 can set preferences for displaying the various objects on the views 205, 210. For example, the views 205, 210 illustrate various power utility data objects such as residences 201 and power lines 202 to the residences 201, shown in the view 210. In addition, the example illustrates hospital objects 211, 212, 213 as the main piece of GIS data that has changed. The hospital objects 211, 212, 213 are illustrated as triangles enclosing an “H”. These object preferences can be selected by the object control 255.

As discussed herein, FIG. 2 illustrates an example of a GUI 200 showing GIS power utility changes in a specific geographical area for the date Aug. 16, 2010 in the view 205 and the date Sep. 27, 2010 in the view 210. In the view 205, the GIS data shows a hospital, as represented by the hospital object 211. In the view 210, the GIS data reveals that there are two new hospitals extracted from the historical GIS database 125, represented by hospital objects 212, 213. The comparisons of the views 205, 210 also reveal that the hospital object 211 is powered by a power cable 216 that is no longer servicing the hospital object 211. The view 210 now shows that the hospital object 211 is serviced by a power cable 217, and the new hospital object 213 is serviced by a power cable 218. Furthermore, the hospital object 212 is not currently serviced by any power cable, likely indicating that it is still under construction. As such, the GUI 200 provides a simple and user-friendly visualization of the differences between data at any two given instances of time.

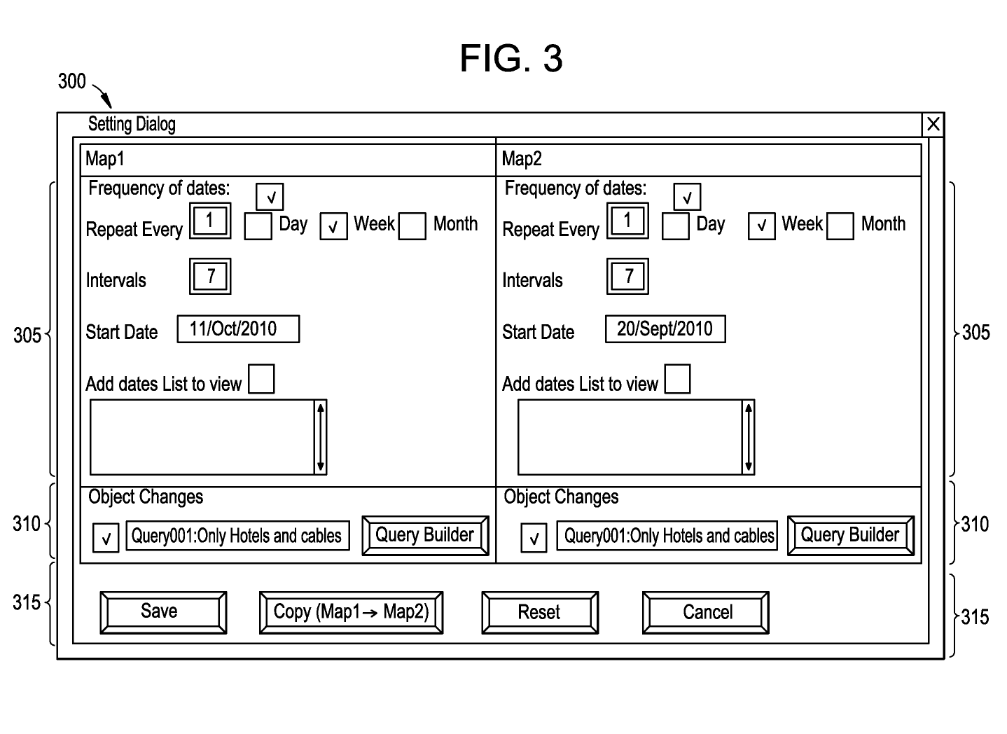

FIG. 3 illustrates an example of a screen shot of a settings GUI 300 in accordance with exemplary embodiments, which can be accessed by the settings control 235 described in FIG. 2. The settings GUI 300 can be implemented to set various date preferences as well as what changes to illustrate in the views (e.g., the views 205, 210 in FIG. 2). The settings GUI 300 can include a frequency of dates control section 305, giving options such as repeating every N number of days, weeks or months, which then sets the dates in the views (e.g., the dates 220 for the control data selection control 215 in FIG. 2). In setting the dates, the settings GUI 300 can further define the intervals at which to set the dates, as well as a starting date, and any additional dates to add. The settings GUI 300 can further include an object changes control section 310, giving options to show what type of object changes to illustrate from the GIS data, as well as a query builder control to send an inquiry to the builder as to specific changes that occurred in the GIS data. The settings GUI 300 can further include a basic controls section 315, including basic controls such as save, cancel, reset and an option to copy the data between the views (e.g., the views 205, 210 of FIG. 2).

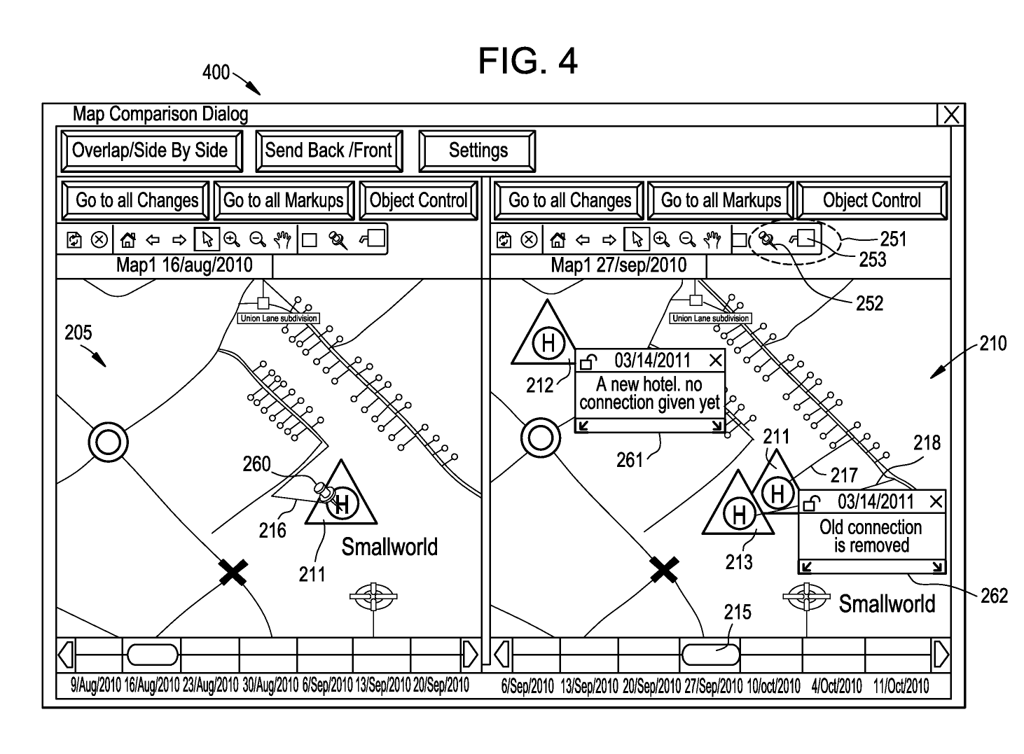

FIG. 4 illustrates an example of a screen shot of a GUI 400 for graphical comparison of GIS data with included user annotations in accordance with exemplary embodiments. The example of FIG. 4 is the same example of FIG. 2 with the added user annotations. As described herein, the user annotation controls 251 can be implemented to add markings and text to the views 205, 210. In exemplary embodiments, the GUI 400 includes a marker control 252 and a text control 253 to add the markers and text as described herein. In the example in FIG. 4, a user added a marker 260 on the hospital object 211. In the second view, the marker 260 further includes user added text 261 over the hospital object 212 indicating that there is no power supplied at this time, and user added text 262 over the hospital object 211 indicating that the power cable 216 has been disconnected from the hospital object 211 and a new power cable 218 has been connected to the hospital object 211.

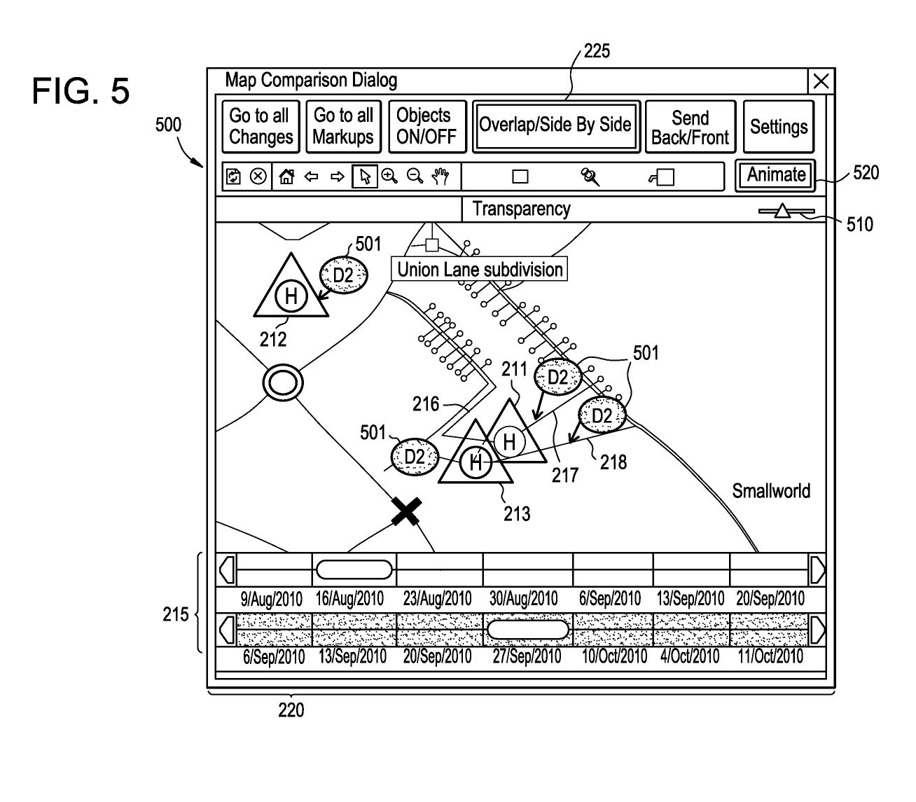

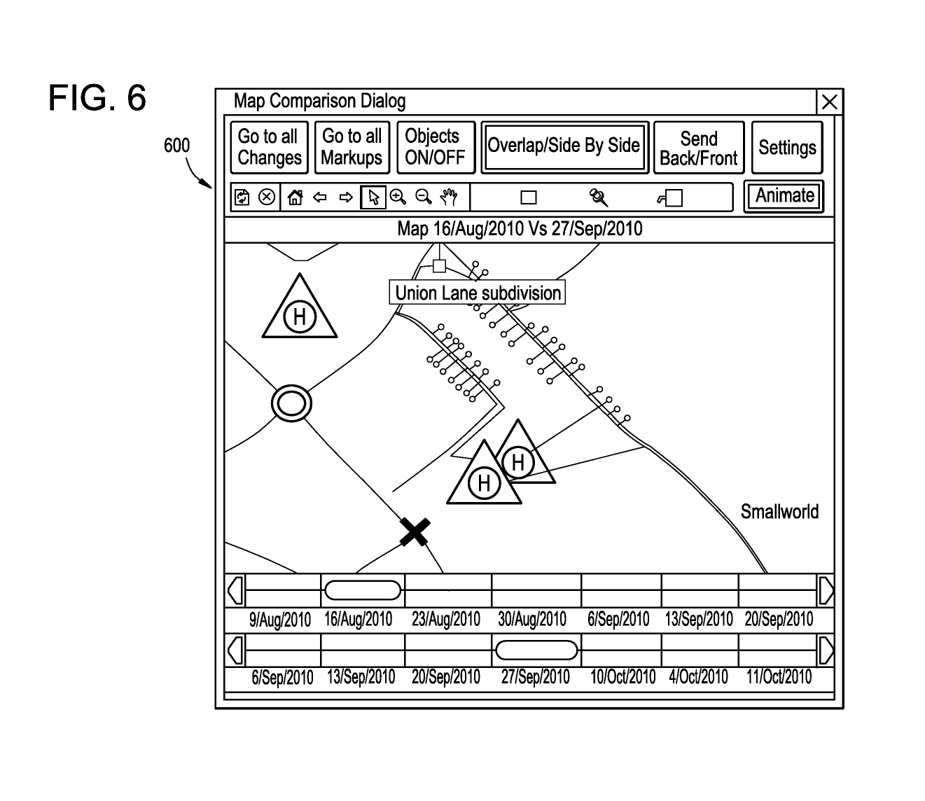

FIG. 5 illustrates an example of a screen shot of a GUI 500 for graphical comparison of GIS data in which two views have been overlapped in accordance with exemplary embodiments. The example of FIG. 5 is the same example of FIG. 2 with the views 205, 210 overlapped. As described herein, the user annotation controls 251 can be implemented to add markings and text to the views 205, 210. By overlapping the views, 205, 210, the data selection control 215 and the dates have also been overlapped and can be differentiated by color or gray shading, or any other exemplary technique. The overlapped views 205, 210 illustrate the three hospital objects 211, 212, 213, and the power cables 216, 217, 218 as in the previous views. In exemplary embodiments, the overlapped views in the GUI 500 further illustrate automatically generated annotations 501 to mark the changes between the dates. The automatically generated annotations 501 can include alphanumeric symbols to match the changes with the later date, for example. In the example, the automatically generated annotations 501 include “D2” and are gray-shade matched with the data selection control 215 of the later date to show the user the date match-up with the changes. In other exemplary embodiments, the overlapped views can be differentiated with color. The overlapped views in the GUI 500 also generate a transparency control 510, which allows the user to adjust the transparency between the two views for ease of viewing. As illustrated, there is a degree of transparency between the hospital objects 211, 213. The overlapped views in the GUI 500 further generate an animate control 520. When the user depresses the animate control 520, the two overlapped views generate the views and changes one by one as indicated by the selected dates and intervals under the settings control 235. In this way, a user can view one by one the changes over time in an animated manner. FIG. 6 illustrates a screen shot of a GUI 600 in which the animation has complete and all objects are shown.

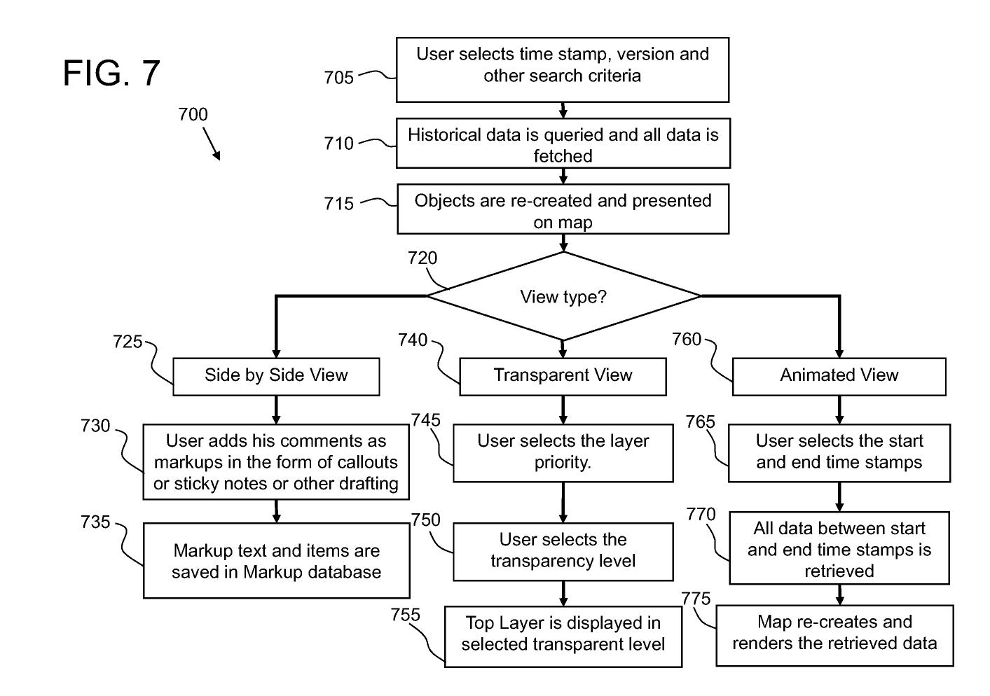

FIG. 7 illustrates a flow chart of a method 700 for generating graphical comparisons of GIS data in accordance with exemplary embodiments. As described herein a user has several options in generating views for comparing the GIS data. At block 705 the user selects a time stamp, version of data and any other search criteria to compare GIS data from two different dates. At block 710, the system 100 then queries historical data and retrieves all data for the desired comparison. As described herein, the data is retrieved from the historical GIS database 125 having historical GIS data of the geographical area, the historical GIS data including the two dates. The current data can be retrieved from the main database 120 that stores current GIS data. At block 715, the system then creates all objects (current and historic) on the GUI described herein (e.g., the GUI 200 in FIG. 2). At block 720, the user then selects the view type as described herein. If at block 720, the user selects a side-by-side view (e.g., in FIG. 2) via the overlap/side by side view control 225, then at block 725, then the system 100 renders a side by side view of the GIS data on the GUI 200. At block 730, the user can then add comments as markups in the form of callouts, sticky notes or any other suitable graphical image. At block 735, the system 100 then saves any markup text and graphical images in the mark-up database 130. If at block 720, the user selects a transparent view (e.g., as in FIG. 5), via the overlap/side by side view control 225, then at block 740, the system 100 renders a transparent view of the GIS data on the GUI 500. At block 745, the user can select a layout priority, such as which images are up from and which are in back for purposes of setting transparency. At block 750, the user can then set the transparency level, such as by adjusting the transparency control 510. At block 755, the system 100 then displays the top layer (as determined by selecting the priority of objects at block 745) with the selected level of transparency. If at block 720, the user selected an animated view (e.g., in FIG. 6), via the animate control 520, then at block 760 the system 100 renders an animation of the GIS data on the GUI 600. At block 765, the user selects the start and end time stamps from the corresponding dates 220 via the data selection control 215. At block 770, the system 100 retrieves all GIS data between the start and end time stamps. At block 775, the system 100 then recreates and renders all the data, date by date on the GUI 600.

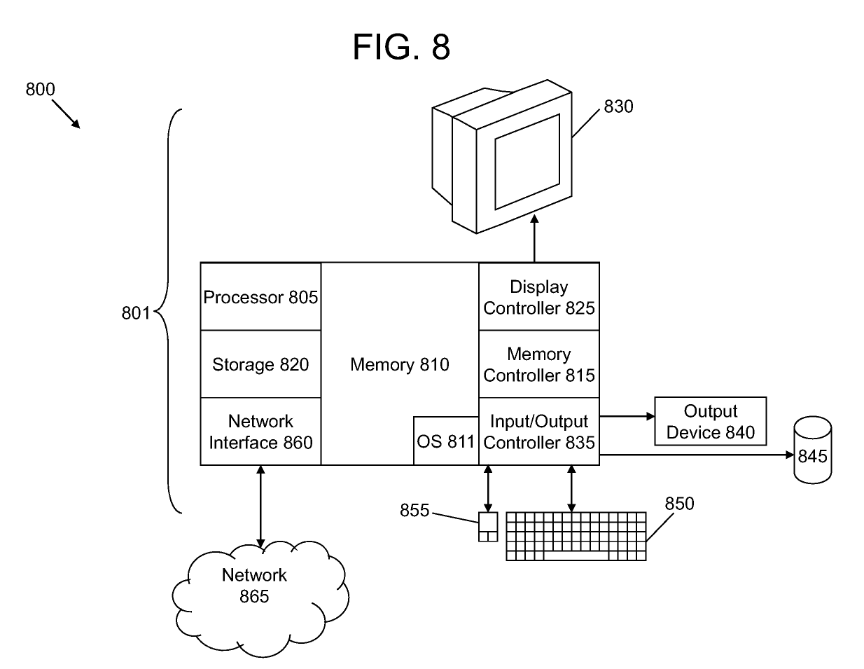

In exemplary embodiments, the system 100 can be part of any suitable computing system as now described. FIG. 8 illustrates an exemplary embodiment of a system 100 for generating a graphical comparison of GIS data. The methods described herein can be implemented in software (e.g., firmware), hardware, or a combination thereof In exemplary embodiments, the methods described herein are implemented in software, as an executable program, and is executed by a special or general-purpose digital computer, such as a personal computer, workstation, minicomputer, or mainframe computer. The system 800 therefore includes general-purpose computer 801.

In exemplary embodiments, in terms of hardware architecture, as shown in FIG. 8, the computer 801 includes a processor 805, memory 810 coupled to a memory controller 815, and one or more input and/or output (I/O) devices 840, 845 (or peripherals) that are communicatively coupled via a local input/output controller 835. The input/output controller 835 can be, but is not limited to, one or more buses or other wired or wireless connections, as is known in the art. The input/output controller 835 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 805 is a hardware device for executing software, particularly that stored in memory 810. The processor 805 can be any custom made or commercially available processor, a central processing unit (CPU), an auxiliary processor among several processors associated with the computer 801, a semiconductor based microprocessor (in the form of a microchip or chip set), a macroprocessor, or generally any device for executing software instructions.

The memory 810 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 810 may incorporate electronic, magnetic, optical, and/or other types of storage media. Note that the memory 810 can have a distributed architecture, where various components are situated remote from one another, but can be accessed by the processor 805.

The software in memory 810 may include one or more separate programs, each of which comprises an ordered listing of executable instructions for implementing logical functions. In the example of FIG. 8, the software in the memory 810 includes the GIS data graphical comparison methods described herein in accordance with exemplary embodiments and a suitable operating system (OS) 811. The OS 811 essentially controls the execution of other computer programs, such the GIS data graphical comparison systems and methods as described herein, and provides scheduling, input-output control, file and data management, memory management, and communication control and related services.

The GIS data graphical comparison methods described herein may be in the form of a source program, executable program (object code), script, or any other entity comprising a set of instructions to be performed. When a source program, then the program needs to be translated via a compiler, assembler, interpreter, or the like, which may or may not be included within the memory 810, so as to operate properly in connection with the OS 811. Furthermore, the GIS data graphical comparison methods can be written as an object oriented programming language, which has classes of data and methods, or a procedure programming language, which has routines, subroutines, and/or functions.

In exemplary embodiments, a conventional keyboard 850 and mouse 855 can be coupled to the input/output controller 835. Other output devices such as the I/O devices 840, 845 may include input devices, for example but not limited to a printer, a scanner, microphone, and the like. Finally, the I/O devices 840, 845 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 800 can further include a display controller 825 coupled to a display 830. In exemplary embodiments, the system 800 can further include a network interface 860 for coupling to a network 865. The network 865 can be an IP-based network for communication between the computer 801 and any external server, client and the like via a broadband connection. The network 865 transmits and receives data between the computer 801 and external systems. In exemplary embodiments, network 865 can be a managed IP network administered by a service provider. The network 865 may be implemented in a wireless fashion, e.g., using wireless protocols and technologies, such as WiFi, WiMax, etc. The network 865 can also be a packet-switched network such as a local area network, wide area network, metropolitan area network, Internet network, or other similar type of network environment. The network 865 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 801 is a PC, workstation, intelligent device or the like, the software in the memory 810 may further include a basic input output system (BIOS) (omitted for simplicity). The BIOS is a set of essential software routines that initialize and test hardware at startup, start the OS 811, and support the transfer of data among the hardware devices. The BIOS is stored in ROM so that the BIOS can be executed when the computer 801 is activated.

When the computer 801 is in operation, the processor 805 is configured to execute software stored within the memory 810, to communicate data to and from the memory 810, and to generally control operations of the computer 801 pursuant to the software. The GIS data graphical comparison methods described herein and the OS 811, in whole or in part, but typically the latter, are read by the processor 805, perhaps buffered within the processor 805, and then executed.

When the systems and methods described herein are implemented in software, as is shown in FIG. 8, the methods can be stored on any computer readable medium, such as storage 820, for use by or in connection with any computer related system or method.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In exemplary embodiments, where the GIS data graphical comparison methods are implemented in hardware, the GIS data graphical comparison methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Technical effects include the ability to quickly and easily view the history of changing GIS data in a particular geographical region. In the event of power failure or outages, a user can compare how a network was built, which can aid in putting long-term preventative plans into place. Technical effects further include gaining an understanding of how to make power distribution networks more reliable and more robust, which aid in developing design practices. The systems and methods described herein also prevent data inconsistency while importing external data

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. In a computer system having a graphical user interface (GUI), including a display and a selection device, a method for generating a graphical comparison of geographic information system (GIS) data, the method comprising:
displaying a plurality of controls on the display, each of the plurality of controls for generating a response in GIS data on the display;
receiving a GIS data selection signal indicative of the selection device pointing at a GIS data selection control on the GUI; and
in response to the GIS data selection signal, retrieving GIS data from a GIS database for display on the GUI,
wherein the GIS data includes data from at least one historical point in time.

2. The method as claimed in claim 1 wherein the GUI includes a first date view and a second date view.

3. The method as claimed in claim 2 wherein the first date view includes GIS data includes GIS data from a first historical date and the second date view includes data from a second historical date.

4. The method as claimed in claim 2 further comprising:
receiving a view selection signal indicative of the selection device pointing at a view control on the GUI; and
in response to the view selection signal, rendering a side by side comparison of the first date view and the second date view on the display.

5. The method as claimed in claim 2 further comprising:
receiving a view selection signal indicative of the selection device pointing at a view control on the GUI; and
in response to the view selection signal, rendering a transparent comparison of the first date view and the second date view on the display.

6. The method as claimed in claim 5 further comprising:
receiving a transparency selection signal indicative of the selection device pointing at a transparency control on the GUI; and
in response to the transparency selection signal, setting a level of transparency between the first date view and the second date view on the display.

7. The method as claimed in claim 2 further comprising:
receiving an animation selection signal indicative of the selection device pointing at an animation control on the GUI; and
in response to the animation selection signal, rendering an animation comparison of the first date view and the second date view on the display.

8. The method as claimed in claim 1 wherein the GIS data includes a plurality of graphical objects representing different pieces of geographical information.

9. The method as claimed in claim 8 further comprising:
receiving a user annotation selection signal indicative of the selection device pointing at a user annotation control on the GUI; and
in response to the user annotation selection signal, rendering user annotations on the display, the user annotations representing information related to the graphical objects.

10. The method as claimed in claim 2 further comprising:
receiving a settings selection signal indicative of the selection device pointing at a settings control on the GUI; and
in response to the settings signal, setting at least one of a frequency of dates, an interval of dates, a start time stamp and an end time stamp for the first date view and the second date view.

11. A computer program product for graphically illustrating a comparison of geographic information system (GIS) data, the computer program product including a non-transitory computer readable medium storing instructions for causing a computer to implement a method in a computer system having a graphical user interface (GUI), including a display and a selection device, the method comprising:
displaying a plurality of controls on the display, each of the plurality of controls for generating a response in GIS data on the display;
receiving a GIS data selection signal indicative of the selection device pointing at a GIS data selection control on the GUI; and
in response to the GIS data selection signal, retrieving GIS data from a GIS database for display on the GUI,
wherein the GIS data includes data from at least one historical point in time.

12. The computer program product as claimed in claim 11 wherein the GUI includes a first date view and a second date view.

13. The computer program product as claimed in claim 12 wherein the method further comprises:
receiving a view selection signal indicative of the selection device pointing at a view control on the GUI; and
in response to the view selection signal, rendering a side by side comparison of the first date view and the second date view on the display.

14. The computer program product as claimed in claim 12 wherein the method further comprises:
receiving a view selection signal indicative of the selection device pointing at a view control on the GUI; and
in response to the view selection signal, rendering a transparent comparison of the first date view and the second date view on the display.

15. The computer program product as claimed in claim 14 wherein the method further comprises:
receiving a transparency selection signal indicative of the selection device pointing at a transparency control on the GUI; and
in response to the transparency selection signal, setting a level of transparency between the first date view and the second date view on the display.

16. The computer program product as claimed in claim 12 wherein the method further comprises:
receiving an animation selection signal indicative of the selection device pointing at an animation control on the GUI; and
in response to the animation selection signal, rendering an animation comparison of the first date view and the second date view on the display.

17. The computer program product as claimed in claim 12 wherein the GIS data includes a plurality of graphical objects representing different pieces of geographical information.

18. The computer program product as claimed in claim 17 wherein the method further comprises:
receiving a user annotation selection signal indicative of the selection device pointing at a user annotation control on the GUI; and
in response to the user annotation selection signal, rendering user annotations on the display, the user annotations representing information related to the graphical objects.

19. The computer program product as claimed in claim 12 wherein the method further comprises:
receiving a settings selection signal indicative of the selection device pointing at a settings control on the GUI; and
in response to the settings signal, setting at least one of a frequency of dates, an interval of dates, a start time stamp and an end time stamp for the first date view and the second date view.

20. A system for generating a graphical comparison of geographic information system (GIS) data, the system comprising:
a display;
a historical GIS database including GIS data that can be displayed on the display; and
a mark-up database including user annotation data that can be displayed on the display,
wherein the display includes a first date view of the GIS data and a second view of the GIS data comparing differences between the first date view and the second date view, the user annotation data providing information related to the differences between the first date view and the second date view.
